(19) United States
(12) Patent Application Publication
(10) Pub. No.: US 2010/0063654 A1
(43) Pub. Date: Mar. 11, 2010

(54) Locator Beacon Disposed Internal to an Enclosure of a Flight Data Recorder and Method Therefor

(75) Inventors: Michael C. Winterhalter, Nokomis, FL (US); Endre Berecz, Bradenton, FL (US)

Correspondence Address: DARBY & DARBY P.C., P.O. BOX 770, Church Street Station, New York, NY, 10008-0770, US

(73) Assignee: L-3 Communications Corporation, New York, NY (US)

(21) Appl. No.: 12/206,585

(22) Filed: Sep. 8, 2008

(51) Int. Cl. G06F 19/00; B64D 45/00

(52) U.S. Cl. 701/14; 29/592.1; 29/594

(57) ABSTRACT

A flight data recorder includes an enclosure and electronic interface within the enclosure. The electronic interface is coupled for receiving data. A crash survivable memory unit is disposed within the enclosure. The crash survivable memory unit includes a memory module electrically coupled to the electronic interface for storing the data. A locator beacon is disposed within the enclosure or within the crash survivable memory unit. The locator beacon is an acoustic resonator which emits ultrasonic pulses. A battery is disposed within the enclosure or within the crash survivable memory unit for providing operating power to the locator beacon. The battery is rechargeable. The battery status is stored in the memory module. A beacon control circuit is disposed within the enclosure or within the crash survivable memory unit for monitoring the battery. A beacon activation device detects a crash event and notifies the beacon control circuit to activate the locator beacon.

### FIELD OF THE INVENTION

The present invention relates in general to avionics and, more particularly, to a flight data recorder having a locator beacon disposed internal to the enclosure.

### BACKGROUND OF THE INVENTION

Most commercial and military aircraft, as well as many civilian aircraft, carry flight data recorders (FDRs) or cockpit voice recorders (CVRs). During normal flight operations, the FDR records specific aircraft performance parameters, such as air speed, altitude, vertical acceleration, time, magnetic heading, control-column position, rudder-pedal position, control-wheel position, horizontal stabilizer, and fuel flow. The CVR records cockpit voices and other audio such as conversations between ground control and flight crew. The FDR and CVR have an enclosure containing electronic interface and processing circuits and a crash survivable memory unit (CSMU). The CSMU contains non-volatile memory for storing the flight data and voice data.

In the event of a crash, most of the flight data recorder chassis and inner components may be damaged. However, the CSMU is designed to survive the impact, potential ensuing fire, submersion, and aftermath of various environmental conditions. For example, under the EUROCAE ED-112 standard, the flight data recorder is required to withstand an impact of 3600 g and temperatures up to 1000° C. The data stored on the CSMU should still be recoverable.

Popularly known as the “black box” and regulated by International Civil Aviation Organization (ICAO), these units are crucial in investigating and understanding aircraft accidents. In fact, the recovery of the black box is second only to the recovery of survivors and victims. FDRs can also be used to study air safety, material degradation, flying procedures, and jet engine performance. The outer housing of the flight data recorder is painted bright orange for ready identification and is generally located in the tail section of the aircraft to maximize survivability.

To assist in recovery of the FDR, a locator beacon emits ultrasonic pulses which can be tracked by equipment operated by rescue crews. The locator beacon is a separate unit, typically cylindrical in shape, which is bolted to the external housing of the FDR. The locator beacon is battery operated to ensure functional operation after a crash. The battery must be replaced periodically because FDRs have no means of monitoring the charge state of the battery or to recharge the battery. Thus, the service interval of the FDR is in part limited by the locator beacon battery. Personnel must physically inspect the battery date to determine replacement time.

Since the locator beacon is mounted to the FDR external housing, it is susceptible to g-forces of the impact, heat of ensuing fire, submersion, and other environmental conditions. The external locator beacon is a self-contained device, i.e., it contains a battery and beacon control circuit necessary to maintain operation. Once activated, the locator beacon requires no interaction or support from the main body of the FDR. The separate, self-contained aspect of the locator beacon adds to the form factor and weight of the FDR and increases manufacturing costs.

### SUMMARY OF THE INVENTION

A need exists for an FDR without an external, self-contained locator beacon. Accordingly, in one embodiment, the present invention is a flight data recorder comprising an enclosure and electronic interface disposed within the enclosure. The electronic interface is coupled for receiving data. A crash survivable memory unit is disposed within the enclosure. The crash survivable memory unit includes a memory module electrically coupled to the electronic interface for storing the data. A locator beacon is disposed within the enclosure. A battery is disposed within the enclosure for providing operating power to the locator beacon. A beacon control circuit is disposed within the enclosure for monitoring the battery.

In another embodiment, the present invention is a data recorder comprising an enclosure and electronic interface disposed within the enclosure. The electronic interface is coupled for receiving data. A crash survivable memory unit is disposed within the enclosure. The crash survivable memory unit includes a memory module electrically coupled to the electronic interface for storing the data. An acoustic resonator is disposed within the enclosure for emitting ultrasonic pulses. A battery is disposed within the enclosure for providing operating power to the acoustic resonator.

In another embodiment, the present invention is an aircraft comprising an airframe and flight data recorder mounted to the airframe. The flight data recorder includes an enclosure and electronic interface disposed within the enclosure. The electronic interface is coupled for receiving data. The flight data recorder further includes a crash survivable memory unit disposed within the enclosure. The crash survivable memory unit includes a memory module electrically coupled to the electronic interface for storing the data. The flight data recorder further includes a locator beacon disposed within the enclosure, and a battery disposed within the enclosure for providing operating power to the locator beacon.

In another embodiment, the present invention is a method of making a data recorder comprising the steps of providing an enclosure and electronic interface disposed within the enclosure. The electronic interface is coupled for receiving data. The method further includes the step of providing a crash survivable memory unit disposed within the enclosure. The crash survivable memory unit includes a memory module electrically coupled to the electronic interface for storing the data. The method further includes the steps of providing a locator beacon disposed within the enclosure and battery disposed within the enclosure for providing operating power to the locator beacon.

### BRIEF DESCRIPTION OF THE DRAWINGS

FIG. 1 is a perspective view of an aircraft with a flight data recorder;

FIGS. 2a-2b show an enclosure for the flight data recorder with an integral reserve power supply physically residing within a form factor of the enclosure;

FIG. 3 is a cut-away view of the flight data recorder showing the crash survivable memory unit;

FIG. 4 illustrates a locator beacon disposed internal to the enclosure;

FIG. 5 illustrates redundant locator beacons disposed in the crash survivable memory unit;

FIG. 6 illustrates an alternate embodiment of the locator beacon disposed in the base of the crash survivable memory unit; and

FIG. 7 illustrates another embodiment of the redundant locator beacons disposed in the memory module housing.

### DETAILED DESCRIPTION OF THE DRAWINGS

The present invention is described in one or more embodiments in the following description with reference to the Figures, in which like numerals represent the same or similar elements. While the invention is described in terms of the best mode for achieving the invention's objectives, it will be appreciated by those skilled in the art that it is intended to cover alternatives, modifications, and equivalents as may be included within the spirit and scope of the invention as defined by the appended claims and their equivalents as supported by the following disclosure and drawings.

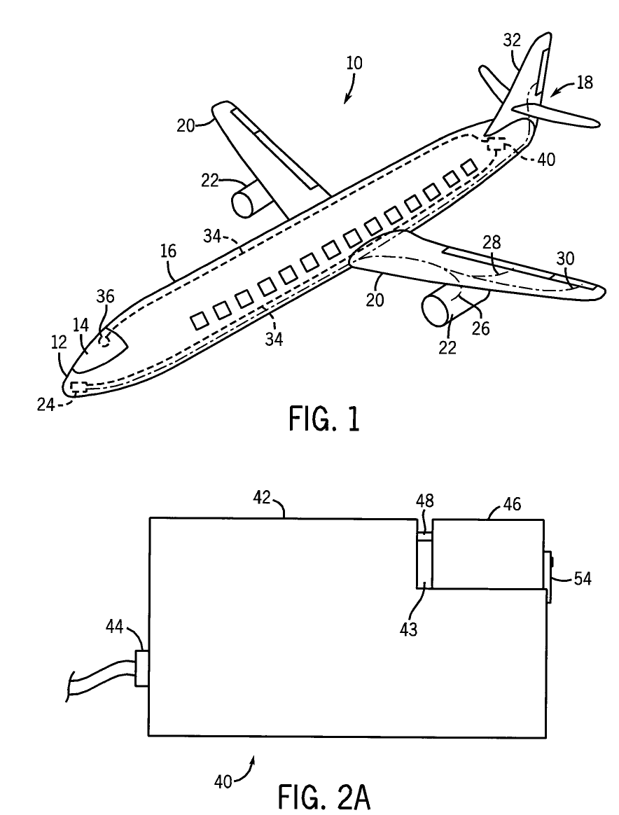

Referring to FIG. 1, a commercial aircraft 10 is shown with nose section 12, cockpit 14, fuselage or airframe 16, tail section 18, wings 20, and engines 22. A flight data acquisition unit 24 can be positioned in nose 12 to acquire flight information, such as air speed, altitude, vertical acceleration, time, magnetic heading, control-column position, rudder-pedal position, control-wheel position, wing flap position, horizontal stabilizer, fuel flow, and landing gear position, from corresponding sensors located throughout aircraft 10. Sensors are placed on critical surfaces and system components of the aircraft to convert real-time physical flight measurements into electrical signals for flight data acquisition unit 24. Typical aircraft sensors include engine speed sensor 26, wing flap position sensor 28, aileron position sensor 30, and rudder position sensor 32. Aircraft sensors 26-32 can be connected to flight data acquisition unit 24 through a fly-by-wire data bus 34 or wireless channel. Other flight related information, e.g., audio and video data, is collected by audio/video recorder 36 which can be located in the cockpit, passenger area, cargo hold, and landing gear compartment. The flight data acquisition unit 24 and audio/video recorder 36 route flight related information to flight data recorder 40 by data bus 34, direct link, or wireless transmission. Flight data recorder 40 is mounted to airframe 16, typically in the tail section of the aircraft to maximize survivability. Flight data recorder 40 can be implemented as a flight data recorder (FDR), cockpit voice recorder (CVR), cockpit voice and flight data recorder (CVDR), or other combination flight data and audio/video recorder.

Flight data recorder 40 is applicable to fixed wing and rotor aircraft, including commercial jets, military aircraft, drones, ultra-light aircraft, blimps, balloons, and flying wings. The data recorder can also be adapted to marine transportation systems such as boats, submarines, hovercraft, also spanning to pleasure/recreational, scientific, commercial, land-based vehicles, and space travel.

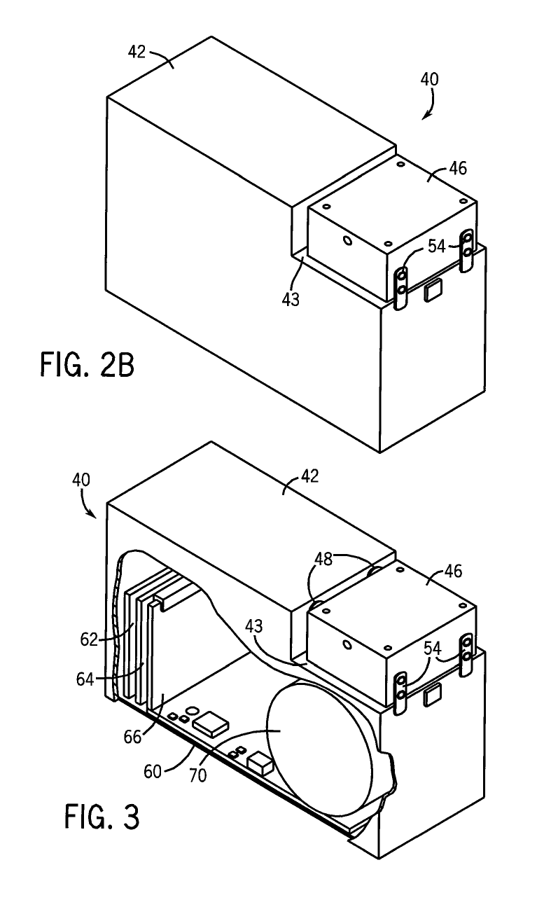

Further detail of flight data recorder 40 is shown in FIGS. 2a and 2b. FIG. 2a is a side view; FIG. 2b is a perspective view of flight data recorder 40. Flight data recorder 40 records flight data and audio/video data. Flight data recorder 40 is a line replaceable unit that simultaneously records audio, video, controller pilot data link communication (CPDLC) messages, and flight data. Flight data recorder 40 includes a compact, lightweight, environmentally sealed enclosure 42 with electrical connector 44 for receiving flight related information from flight data acquisition unit 24 and audio/video recorder 36 via data bus 34. Alternatively, the flight related information can be relayed by direct link or wireless transmission. In one embodiment, connector 44 is a 57 pin, DPXB-style connector with a data rate of 1024 words per second. Enclosure 42 is a 1/2-ATR short, waterproof case which is compliant with ARINC 404A. Enclosure 42 has a generally rectangular form factor with an L-shaped notch or cut-out 43 formed along one side or corner of the case. Notch 43 can also be U-shaped and disposed in a mid-section of any surface of enclosure 42.

A recorder independent power supply (RIPS) 46 is a self-contained battery-pack module that is mounted to and physically resides within notch 43 of enclosure 42. RIPS 46 is secured to enclosure 42 by electrical connector 48 and mechanical clamps 54. RIPS 46 provides a reserve operating voltage and electrical power to printed circuit boards (PCB) and electronic components located within enclosure 42 by way of electrical connector 48. RIPS 46 typically uses nickel cadmium (NiCd) or lithium ion (Li-Ion) batteries. RIPS 46 is recharged from the aircraft power bus or flight data recorder main power supply. RIPS 46 is capable of providing 28 VDC at 12 watts (W) for about 10.5 minutes.

RIPS 46 and electrical connector 48 are integral components of flight data recorder 40. The physical dimensions of RIPS 46 and electrical connector 48 are disposed within the generally rectangular form factor of the single enclosure 42. That is, RIPS 46 and electrical connector 48 physically reside within the dimensions of notch 43 and provide flight data recorder 40 with reserve operating power without increasing its form factor. In other embodiments, RIPS 46 and electrical connector 48 can be placed inside enclosure 42. In any case, the enclosure 42 of flight data recorder 40, including integral RIPS 46 and electrical connector 48, is compliant with the dimensional specifications for flight data recorders mandated by governing bodies, e.g., TSO 123b and 124b, EUROCAE ED-112, ARINC 747, and ARINC 757.

FIG. 3 is a cut-away view of flight data recorder 40 showing internal PCBs and other electronic components, such as acquisition processor board 60, audio compression board 62, video compression board 64, and aircraft interface board 66. A crash survivable memory unit (CSMU) 70 is electrically connected to PCBs 60-66 for receiving and storing the flight related information, including flight data and audio/video data. CSMU 70 contains a non-volatile memory module which can be implemented as stacked memory cards having solid state flash memory chips, or other non-volatile storage devices such as magnetic or optical mass storage medium. CSMU 70 is constructed for non-pressurized and non-temperature-controlled applications and compliant with the environmental requirements of DO-160F. The outer housing of CSMU 70 is a heat resistant material such as stainless steel. A thermal insulating material is disposed between the outer memory module housing and non-volatile memory module to provide additional protection from the heat. Enclosure 42 is painted international orange for ready identification.

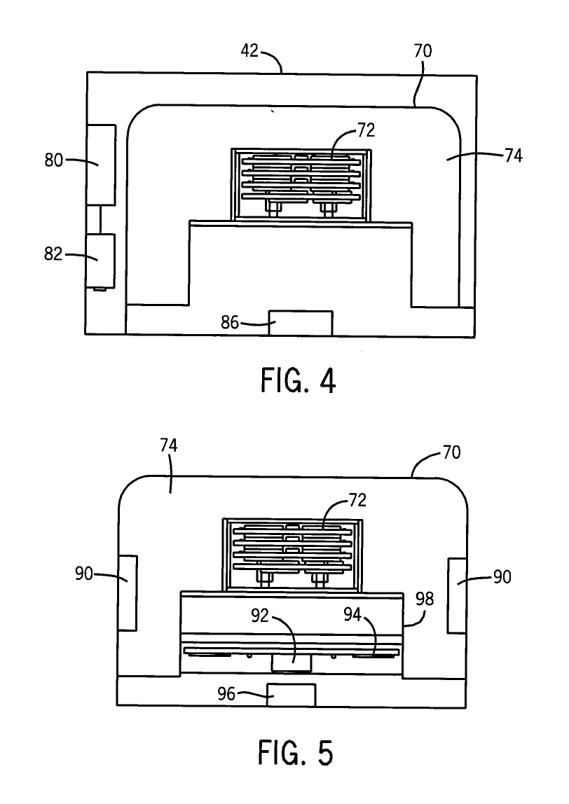

FIG. 4 shows further detail of the interior portion of enclosure 42, CSMU 70, memory module 72, and thermal insulating material 74 surrounding memory module 72. More specifically, a locator beacon 80 is mounted to an internal surface of enclosure 42 using an adhesive. Beacon 80 is a ceramic resonator or acoustic transducer that emits ultrasonic pulses which can be tracked by equipment operated by rescue crews. Beacon 80 can be cast or pressed into any shape and mounted to any interior surface within enclosure 42. For example, beacon 80 can be flat, circular, or rectangular, and mounted to the sides, top, or bottom of enclosure 42. Beacon 80 serves to locate and retrieve flight data recorder 40 in the event of a crash or other aircraft incident.

Battery 82 is also mounted to an internal surface of enclosure 42 using an adhesive. Battery 82 is rechargeable from the flight data recorder main power supply or RIPS 46. A control circuit for locator beacon 80 is integrated into one or more of PCBs 60-66. A beacon activation device 86, e.g., conductive switch, pressure switch, or accelerometer, detects a crash event and notifies the beacon control circuit, which in turn causes operating power from battery 82 to be supplied to beacon 80. Once activated, beacon 80 emits the trackable ultrasonic pulses for the duration of the battery power. The control circuit for beacon 80 monitors battery status, e.g., voltage level, recharge cycles, and length of service. The battery status is stored in memory module 72 for later analysis. The battery status can also be reported to the cockpit during flight operation or evaluated during system testing. The beacon control circuit controls the recharge cycles and maintains a continuous full-charge state for battery 82 during normal operation.

FIG. 5 shows further detail of CSMU 70 with memory module 72 surrounded by thermal insulating material 74. CSMU 70 is contained within enclosure 42. In this embodiment, locator beacon 90 is mounted to an internal surface of CSMU 70 using an adhesive. Beacon 90 is formed in two sections for redundancy and mounted to opposite walls of CSMU 70. Battery 92 and beacon control module 94 are disposed within memory module housing 98, which is contained within CSMU 70, to enhance survivability. Again, battery 92 is rechargeable from the flight data recorder main power supply or RIPS 46. Beacon activation device 96, e.g., conductive switch, pressure switch, or accelerometer, detects a crash event and notifies beacon control circuit 94, which in turn causes operating power from battery 92 to be supplied to beacon 90. Once activated, beacon 90 emits the trackable ultrasonic pulses for the duration of the battery power. Beacon control module 94 monitors battery status, e.g., voltage level, recharge cycles, and length of service. The battery status is stored in memory module 72 for later analysis. The battery status can also be reported to the cockpit during flight operation or evaluated during system testing. Beacon control module 94 controls the recharge cycles and maintains a continuous full-charge state for battery 92 during normal operation.

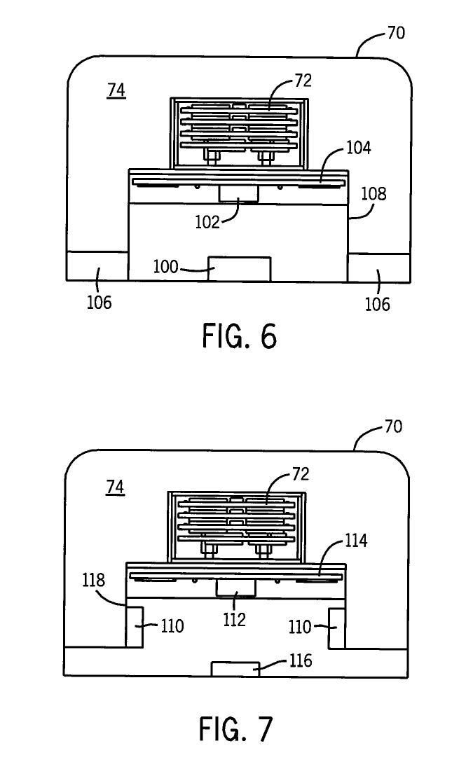

FIG. 6 shows another embodiment with locator beacon 100, battery 102, and beacon control module 104 contained within memory module housing 108 of CSMU 70 to enhance survivability. Beacon 100 can be cast or pressed into any shape and mounted to any surface within CSMU 70. In this case, beacon 100 is mounted to a base of CSMU 70 within memory module housing 108, which is contained in CSMU 70, which in turn is contained within enclosure 42. Likewise, battery 102 and beacon control module 104 are disposed in memory module housing 108. Battery 102 is rechargeable from the flight data recorder main power supply or RIPS 46. Beacon activation device 106, e.g., conductive switch, pressure switch, or accelerometer, detects a crash event and notifies beacon control circuit 104, which in turn causes operating power from battery 102 to be supplied to beacon 100. Once activated, beacon 100 emits the trackable ultrasonic pulses for the duration of the battery power. Beacon control module 104 monitors battery status, e.g., voltage level, recharge cycles, and length of service. The battery status is stored in memory module 72 for later analysis. The battery status can also be reported to the cockpit during flight operation or evaluated during system testing. Beacon control module 104 controls the recharge cycles and maintains a continuous full-charge state for battery 102 during normal operation.

In FIG. 7, locator beacon 110, battery 112, and beacon control module 114 are contained within memory module housing 118 of CSMU 70 to enhance survivability. Beacon 110 can be cast or pressed into any shape and mounted to any surface within CSMU 70. In this embodiment, beacon 110 is formed in two sections for redundancy and mounted to opposite sides of memory module housing 118, which is contained within CSMU 70, which in turn is contained within enclosure 42. Battery 112, beacon control module 114, and beacon activation device 116 are also disposed within memory module housing 118. Battery 112 is rechargeable from the flight data recorder main power supply or RIPS 46. Beacon activation device 116, e.g., conductive switch, pressure switch, or accelerometer, detects a crash event and notifies beacon control circuit 114, which in turn causes operating power from battery 112 to be supplied to beacon 110. Once activated, beacon 110 emits the trackable ultrasonic pulses for the duration of the battery power. Beacon control module 114 monitors battery status, e.g., voltage level, recharge cycles, and length of service. The battery status is stored in memory module 72 for later analysis. The battery status can also be reported to the cockpit during flight operation or evaluated during system testing. Beacon control module 114 controls the recharge cycles and maintains a continuous full-charge state for battery 112 during normal operation.

In summary, the locator beacon is contained within the interior housing of the FDR enclosure, or within the CSMU, or within the memory module housing, for enhanced survivability. By placing the locator beacon within the enclosure, the form factor of the FDR is reduced and simplified for system integration. The prior art locator beacon, which is mounted to external to the FDR enclosure, has been eliminated. The beacon control circuit monitors the battery and maintains a full-charge state to extend service life. No human intervention is needed to inspect the battery, which simplifies and reduces maintenance. The locator beacon need no longer be self-contained as it can utilize the beacon control circuits within the form factor of the FDR enclosure which reduces weight. In addition, since the locator beacon resides within the FDR enclosure, it is compliant with the dimensional specifications for flight data recorders mandated by governing bodies, e.g., TSO 123b and 124b, EUROCAE ED-112, ARINC 747, and ARINC 757.

While one or more embodiments of the present invention have been illustrated in detail, the skilled artisan will appreciate that modifications and adaptations to those embodiments may be made without departing from the scope of the present invention as set forth in the following claims.

What is claimed:

1. A flight data recorder, comprising:
an enclosure;
an electronic interface disposed within the enclosure, the electronic interface being coupled for receiving data;
a crash survivable memory unit disposed within the enclosure, the crash survivable memory unit including a memory module electrically coupled to the electronic interface for storing the data;
a locator beacon disposed within the enclosure;
a battery disposed within the enclosure for providing operating power to the locator beacon; and
a beacon control circuit disposed within the enclosure for monitoring the battery.

2. The flight data recorder of claim 1, wherein the locator beacon is disposed within the crash survivable memory unit.

3. The flight data recorder of claim 1, wherein the beacon control circuit is disposed within the crash survivable memory unit.

4. The flight data recorder of claim 1, wherein the battery is disposed within the crash survivable memory unit.

5. The flight data recorder of claim 1, wherein the battery is rechargeable.

6. The flight data recorder of claim 1, wherein battery status is stored in the memory module.

7. The flight data recorder of claim 1, further including a beacon activation device for detecting a crash event and notifying the beacon control circuit to activate the locator beacon.

8. A data recorder, comprising:
an enclosure;
an electronic interface disposed within the enclosure, the electronic interface being coupled for receiving data;
a crash survivable memory unit disposed within the enclosure, the crash survivable memory unit including a memory module electrically coupled to the electronic interface for storing the data;
an acoustic resonator disposed within the enclosure for emitting ultrasonic pulses; and
a battery disposed within the enclosure for providing operating power to the acoustic resonator.

9. The data recorder of claim 8, further including a control circuit disposed within the enclosure for monitoring the battery.

10. The data recorder of claim 9, wherein the control circuit is disposed within the crash survivable memory unit.

11. The data recorder of claim 9, further including a beacon activation device disposed within the enclosure for detecting a crash event and notifying the control circuit to activate the acoustic resonator.

12. The data recorder of claim 8, wherein the acoustic resonator is disposed within the crash survivable memory unit.

13. The data recorder of claim 8, wherein the battery is disposed within the crash survivable memory unit.

14. The data recorder of claim 8, wherein the battery is rechargeable.

15. The data recorder of claim 8, wherein battery status is stored in the memory module.

16. An aircraft, comprising:
an airframe; and
a flight data recorder mounted to the airframe, the flight data recorder including,
(a) an enclosure,
(b) an electronic interface disposed within the enclosure, the electronic interface being coupled for receiving data,
(c) a crash survivable memory unit disposed within the enclosure, the crash survivable memory unit including a memory module electrically coupled to the electronic interface for storing the data,
(d) a locator beacon disposed within the enclosure, and
(e) a battery disposed within the enclosure for providing operating power to the locator beacon.

17. The aircraft of claim 16, further including a beacon control circuit disposed within the enclosure for monitoring the battery.

18. The aircraft of claim 16, wherein the locator beacon and battery are disposed within the crash survivable memory unit.

19. The aircraft of claim 16, wherein the battery is rechargeable.

20. A method of making a data recorder, comprising:
providing an enclosure;
providing an electronic interface disposed within the enclosure, the electronic interface being coupled for receiving data;
providing a crash survivable memory unit disposed within the enclosure, the crash survivable memory unit including a memory module electrically coupled to the electronic interface for storing the data;
providing a locator beacon disposed within the enclosure; and
providing a battery disposed within the enclosure for providing operating power to the locator beacon.

21. The method of claim 20, further including providing a beacon control circuit disposed within the enclosure for monitoring the battery.

22. The method of claim 21, further including disposing the beacon control circuit within the crash survivable memory unit.

23. The method of claim 21, further including:
detecting a crash event; and
notifying the beacon control circuit to activate the locator beacon.

24. The method of claim 20, further including disposing the locator beacon and battery within the crash survivable memory unit.

25. The method of claim 20, wherein the battery is rechargeable.
